(19) United States
(12) Patent Application Publication
(10) Pub. No.: US 2024/0389516 A1
(43) Pub. Date: Nov. 28, 2024

(54) GARDEN SHEAR

(71) Applicant: Chin-Yuan Chen, CHANGHUA (TW)

(72) Inventor: Chin-Yuan Chen, CHANGHUA (TW)

(73) Assignee: Chin-Yuan Chen, CHANGHUA (TW)

(21) Appl. No.: 18/201,049

(22) Filed: May 23, 2023

(51) Int. Cl. A01G 3/047

(52) U.S. Cl. CPC A01G 3/0475

(57) ABSTRACT

A garden shear may include a main body and two holding members. The main body has a pair of shear blades, and each of the shear blades has a first handle at one end and a through hole on the middle section thereof. Each of the first handles has one holding member disposed on the lower end thereof, and each of the holding members comprises a sleeve. A connecting opening is formed on the top of the sleeve, and the diameter of the connecting opening is gradually smaller from top to bottom. Each of the sleeves comprises a first coated member and a second coated member respectively coated on two side surfaces of the sleeve, and the second coated member is covered with an imitation carbon fiber texture.

### FIELD OF THE INVENTION

The present invention relates to a garden shear and more particularly to a garden shear having improved operation structure for the user.

### BACKGROUND OF THE INVENTION

A conventional garden shear comprises a pair of blades, and each of the blades is connected to a long handle at the lower end thereof, and a through hole is formed on a middle section of the handle, so that a screw is adapted to screw through the through holes, and engage with a nut to pivotally connect the two blades. When the force is applied on the handles, the through holes can be used as the axis to make the blades open and close, so as to complete the cutting purpose, and each of the two handles has a sleeve formed on the lower end of the handle.

However, the conventional garden shear has following disadvantages: the sleeve of the handle is lack of anti-slip performance, and the surface of the sleeve is monotonous and does not have three-dimensional effect of light refraction, and the sleeve is simply put on the handle, which cannot effectively prevent the sleeve from falling off. Therefore, there remains a need for a new and improved design for a garden shear to overcome the problems presented above.

### SUMMARY OF THE INVENTION

The present invention provides a garden shear comprising a main body and two holding members. The main body has a pair of shear blades, and each of the shear blades has a long rod-shaped first handle at one end and a through hole on the middle section thereof, and a screw is adapted to screw through the two through holes to engage with a nut, so as to pivotally connect the two shear blades together. When the force is applied on the first handles, the through holes are configured to be used as the axis to enable the shear blades to open and close, so as to achieve the cutting purpose. Each of the first handles has one holding member disposed on the lower end thereof, and each of the holding members comprises a sleeve. A connecting opening is formed on the top of the sleeve, and the diameter of the connecting opening is gradually smaller from top to bottom. When each of the sleeves is disposed on the lower end of the first handle through the connecting opening, the gradually smaller diameter of the connecting opening is adapted to enable the sleeve to be tightly disposed on the first handle, so as to prevent the holding member from detaching from the first handle. Each of the sleeves comprises a first coated member and a second coated member respectively coated on two side surfaces of the sleeve, and the second coated member is covered with an imitation carbon fiber texture. The imitation carbon fiber texture has continuous ups and downs texture to provide better touch feeling and the anti-slip effect, and the light refraction from the imitation carbon fiber texture also makes the sleeve more dimensional.

Comparing with conventional garden shear, the present invention is advantageous because: (i) the gradually smaller diameter of the connecting opening from top to bottom is adapted to enable the sleeve to be tightly disposed on the first handle; and (ii) the imitation carbon fiber texture has continuous ups and downs texture to provide better touch feeling and the anti-slip effect, and the light refraction from the imitation carbon fiber texture also makes the sleeve more dimensional.

### BRIEF DESCRIPTION OF THE DRAWINGS

FIG. 1 is a three-dimensional assembly view of a garden shear of the present invention.

FIG. 2 is a partial enlarged view of the garden shear of the present invention.

FIG. 3 is a three-dimensional assembly view of a holding member of the garden shear in the present invention.

FIG. 4 is a three-dimensional exploded view of the holding member of the garden shear in the present invention.

FIG. 5 is a sectional assembly view of the holding member of the garden shear in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

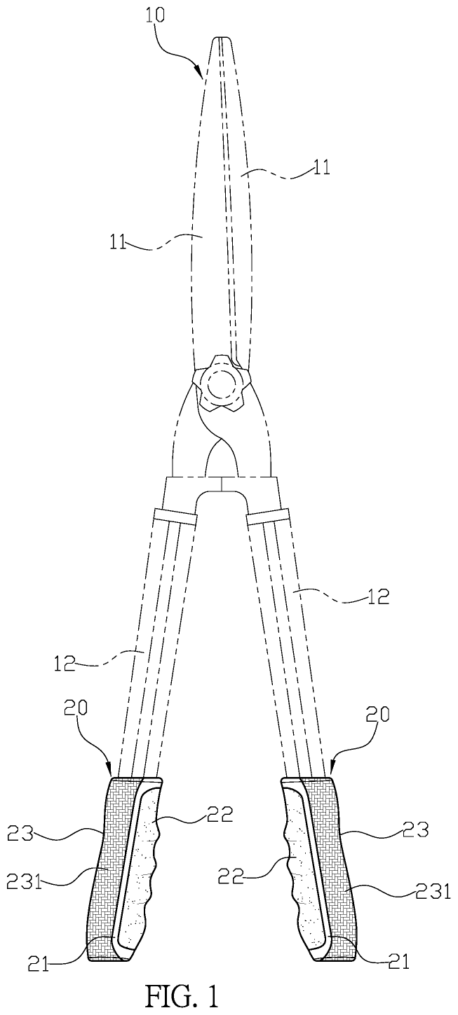

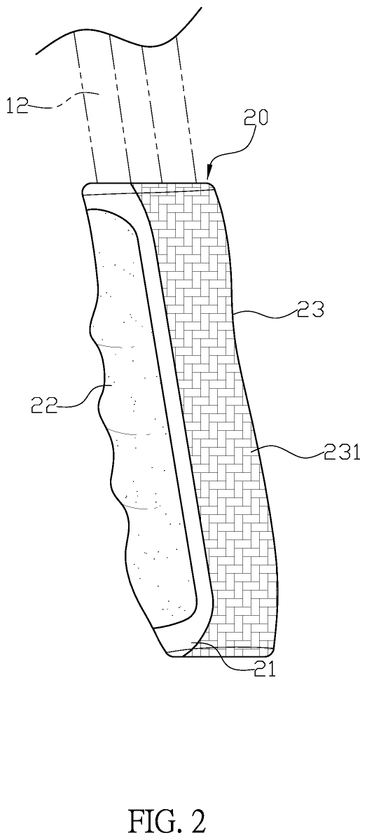

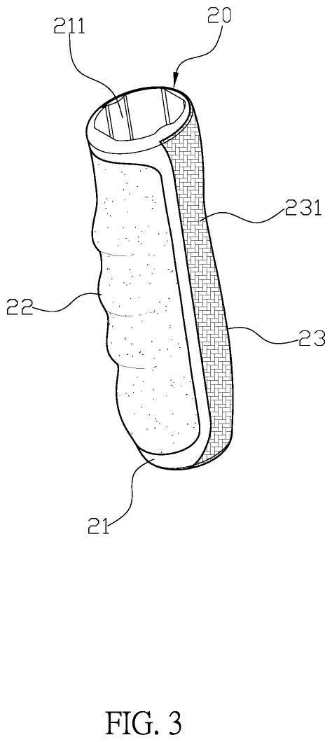

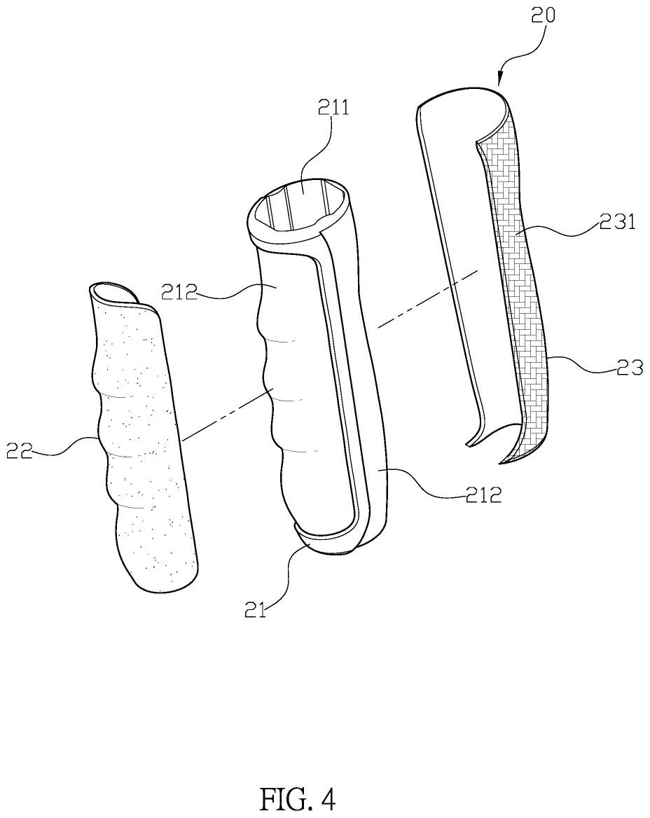

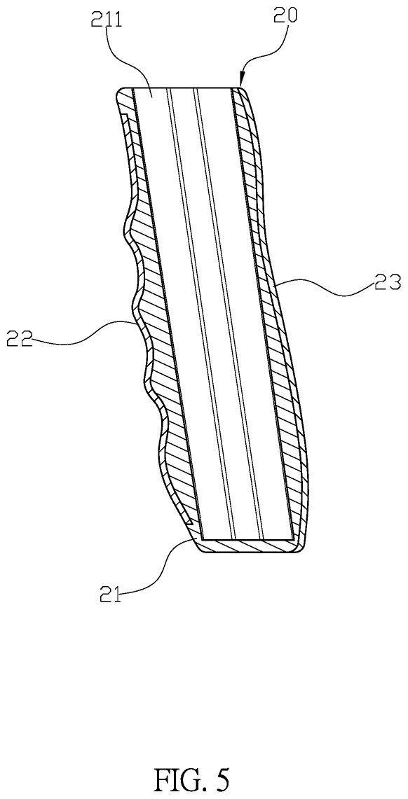

Referring to FIGS. 1 to 5, the present invention provides a garden shear comprising a main body (10) and two holding members (20). The main body (10) has a pair of shear blades (11), and each of the shear blades (11) has a long rod-shaped first handle (12) at one end and a through hole on the middle section thereof, and a screw is adapted to screw through the two through holes to engage with a nut, so as to pivotally connect the two shear blades (11) together. When the force is applied on the first handles (12), the through holes are configured to be used as the axis to enable the shear blades (11) to open and close, so as to achieve the cutting purpose. Each of the first handles (12) has one holding member (20) disposed on the lower end thereof, and each of the holding members (20) comprises a sleeve (21). Moreover, a connecting opening (211) is formed on the top of the sleeve (21), and the diameter of the connecting opening (211) is gradually smaller from top to bottom. When each of the sleeves (21) is disposed on the lower end of the first handle (12) through the connecting opening (211), the gradually smaller diameter of the connecting opening (211) is adapted to enable the sleeve (21) to be tightly disposed on the first handle (12), so as to prevent the holding member (20) from detaching from the first handle (12). Each of the sleeves (21) comprises a first coated member (22) and a second coated member (23) respectively coated on two side surfaces of the sleeve (21), and the second coated member (23) is covered with an imitation carbon fiber texture (231). The imitation carbon fiber texture (231) has continuous ups and downs texture to provide better touch feeling and the anti-slip effect, and the light refraction from the imitation carbon fiber texture (231) also makes the sleeve (21) more dimensional.

In one embodiment, the sleeve (21) is made of hard plastic to improve the overall strength of the holding member (20).

In another embodiment, the first coated member (22) and the second coated member (23) are made of flexible soft plastic, so as to improve the comfort of holding the first coated member (22) and the second coated member (23).

In still another embodiment, the first coated member (22) is coated on the inner side of the outer surface of the sleeve (21) while the second coated member (23) is coated on the outer side of the outer surface of the sleeve (21).

In a further embodiment, each of the sleeves (21) has two recess spaces (212) respectively formed at two lateral sides of the sleeve (21), and the first coated member (22) and the second coated member (23) are adapted to couple on the two recess spaces (212) respectively to connect to the sleeve (21).

Comparing with conventional garden shear, the present invention is advantageous because: (i) the gradually smaller diameter of the connecting opening (211) from top to bottom is adapted to enable the sleeve (21) to be tightly disposed on the first handle (12); and (ii) the imitation carbon fiber texture (231) has continuous ups and downs texture to provide better touch feeling and the anti-slip effect, and the light refraction from the imitation carbon fiber texture (231) also makes the sleeve (21) more dimensional.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A garden shear comprising a main body and two holding members;
wherein the main body has a pair of shear blades, and each of the shear blades has a first handle at one end and a through hole on the middle section thereof, and a screw is adapted to screw through the two through holes to engage with a nut, so as to pivotally connect the two shear blades together; when the force is applied on the first handles, the through holes are configured to be used as the axis to enable the shear blades to open and close, so as to achieve the cutting purpose; each of the first handles has one holding member disposed on the lower end thereof; and
wherein each of the holding members comprises a sleeve, and a connecting opening is formed on the top of the sleeve, and the diameter of the connecting opening is gradually smaller from top to bottom; when each of the sleeves is disposed on the lower end of the first handle through the connecting opening, the gradually smaller diameter of the connecting opening is adapted to enable the sleeve to be tightly disposed on the first handle, so as to prevent the holding member from detaching from the first handle; each of the sleeves comprises a first coated member and a second coated member respectively coated on two side surfaces of the sleeve, and the second coated member is covered with an imitation carbon fiber texture; the imitation carbon fiber texture has continuous ups and downs texture to provide touch feeling and the anti-slip effect, and the light refraction from the imitation carbon fiber texture enables the sleeve more dimensional.

2. The garden shear of claim 1, wherein each of the shear blades has a long-rod shaped first handle at one end.

3. The garden shear of claim 1, wherein the sleeve is made of hard plastic.

4. The garden shear of claim 1, wherein the first coated member and the second coated member are made of soft plastic.

5. The garden shear of claim 1, wherein the first coated member and the second coated member are made of flexible soft plastic.

6. The garden shear of claim 1, wherein each of the sleeves has two recess spaces respectively formed at two lateral sides of the sleeve, and the first coated member and the second coated member are adapted to couple on the two recess spaces respectively to connect to the sleeve.
